(19) United States
(12) Patent Application Publication
(10) Pub. No.: US 2026/0144227 A1
(43) Pub. Date: May 28, 2026

(54) PET BED

(71) Applicant: JIANGSU ZHONGHENG PET ARTICLES JOINT-STOCK CO., LTD., Jiangsu (CN)

(72) Inventor: Bin QIU, Jiangsu (CN)

(73) Assignee: JIANGSU ZHONGHENG PET ARTICLES JOINT-STOCK CO., LTD., Jiangsu (CN)

(21) Appl. No.: 19/398,006

(22) Filed: Nov. 23, 2025

(30) Foreign Application Priority Data
Nov. 27, 2024 (CN) 202422903291.7

(51) Int. Cl. A01K 1/035

(52) U.S. Cl. CPC A01K 1/0353

(57) ABSTRACT

Provided is a pet bed, including a bed body; and a supporting assembly connected to the bed body and located at a position other than an upper end and a lower end of the bed body. The supporting assembly is mounted on the bed body, and a height difference exists between the supporting assembly and a top of the bed body, so that when a supporting pad is mounted, three sides of the supporting pad can be folded upward.

### CROSS REFERENCE TO THE RELATED APPLICATIONS

This application is based upon and claims priority to Chinese Patent Application No. 202422903291.7, filed on Nov. 27, 2024, the entire contents of which are incorporated herein by reference.

### BACKGROUND

### Technical Field

The present disclosure relates to the field of pet products, and specifically to a pet bed.

### Description of Related Art

Pets can enrich people's lives and change people's mood. More and more people start to keep pets and are willing to provide a comfortable place for pets to rest. At present, the supporting pads of some pet beds on the market are suspended off the ground for moisture-proof and insect-proof purposes to effectively reduce the risk of pets getting sick. However, when the supporting pad is suspended off the ground, the upper surface of the pet bed appears to be similar to a flat surface, and pets are likely to fall from the pet bed, resulting in poor pet experience.

### SUMMARY

An objective of the present disclosure is to provide a pet bed to solve the technical problem that when the supporting pad is suspended off the ground, the upper surface of the pet bed appears to be similar to a flat surface, and pets are likely to fall from the pet bed, resulting in poor pet experience.

To achieve the above objective, an embodiment of the present disclosure provides a pet bed, including:
a bed body; and
a supporting assembly, where the supporting assembly is connected to the bed body, and the supporting assembly is located at a position other than an upper end and a lower end of the bed body.

In the above technical solution, the bed body includes:
two supporting members, where the two supporting members are arranged symmetrically; and
a first connection member, where two ends of the first connection member are respectively connected to the two supporting members.

In the above technical solution, the supporting assembly includes:
two second connection members, where two ends of each of the two second connection members are respectively connected to the two supporting members, and the two second connection members are located below the first connection member; and
two third connection members, where two ends of each of the two third connection members are respectively connected to the two second connection members.

In the above technical solution, the supporting assembly includes:
two second connection members, where two ends of each of the two second connection members are respectively connected to the two supporting members, and the two second connection members are located below the first connection member.

Additional aspects and advantages of the present disclosure will be apparent from the description below, or understood through practice of the present disclosure.

### BRIEF DESCRIPTION OF THE DRAWINGS

The above and/or other additional aspects and advantages of the present disclosure will become apparent and comprehensible from the description of embodiments made in connection with the accompanying drawings, in which:

FIG. 1 is an overall schematic structural diagram of Embodiment 1 of the present disclosure.

FIG. 2 is an overall schematic structural diagram of Embodiment 2 of the present disclosure.

### DETAILED DESCRIPTION OF THE EMBODIMENTS

To make the objectives, features, and advantages of the present disclosure more comprehensible, the present disclosure will be described in detail below with reference to the accompanying drawings and specific embodiments. It should be noted that the embodiments of the present disclosure and the features in the embodiments may be combined with each other without conflict.

Many specific details are set forth in the following description to provide a full understanding of the present disclosure. However, the present disclosure can also be implemented in other ways different from those described herein, so the scope of protection of the present disclosure is not limited by the specific embodiments disclosed below.

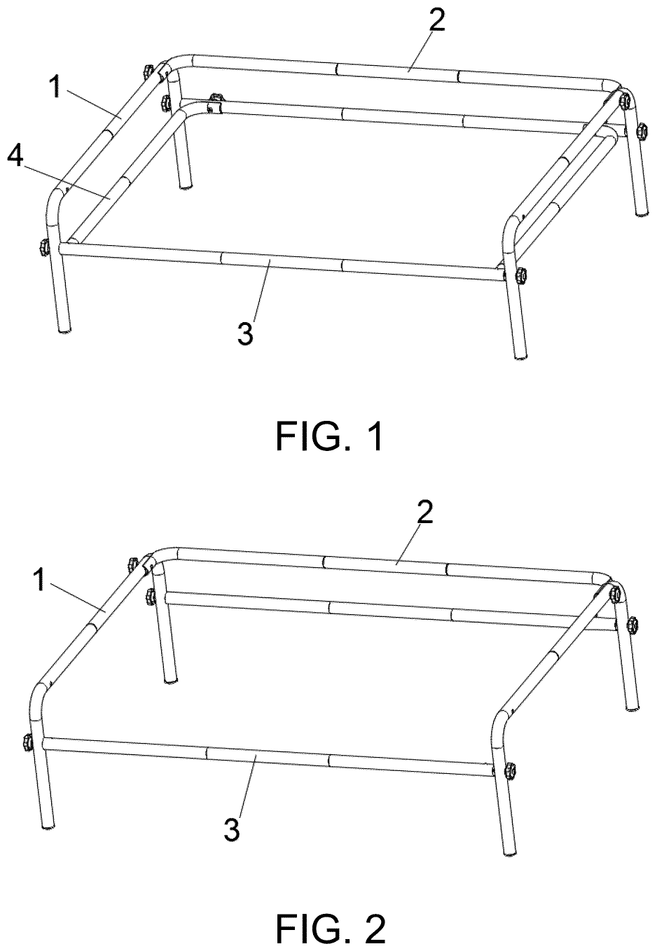

A pet bed according to some embodiments of the present disclosure will be described below with reference to FIG. 1 to FIG. 2.

As shown in FIG. 1 to FIG. 2, an embodiment of the present disclosure provides a pet bed, including a bed body and a supporting assembly.

Specifically, the supporting assembly is connected to the bed body, and the supporting assembly is located at a position other than an upper end and a lower end of the bed body.

The supporting assembly is fixedly mounted on the bed body, so that the supporting assembly is located at a middle portion of the bed body in a height direction of the bed body. Then, a supporting pad may be mounted on the supporting assembly, and an end of the supporting pad may be connected to the upper end of the bed body, allowing a pet to rest on the supporting pad. In addition, because the end of the supporting pad is connected to the upper end of the bed body, the supporting pad can protect the pet, preventing the pet from falling from the supporting pad.

### Embodiment 1

As shown in FIG. 1, in an embodiment of the present disclosure, the bed body includes:
two supporting members 1, where the two supporting members 1 are arranged symmetrically; and
a first connection member 2, where two ends of the first connection member 2 are respectively connected to the two supporting members 1.

The supporting assembly includes:
two second connection members 3, where two ends of each of the two second connection members 3 are respectively connected to the two supporting members 1, and the two second connection members 3 are located below the first connection member 2; and
two third connection members 4, where two ends of each of the two third connection members 4 are respectively connected to the two second connection members 3.

The two supporting members 1 are symmetrically arranged. The two supporting members 1 are each of a U-shape with two right-angled corners, i.e., each supporting member includes two vertical rods and one transverse rod. The two vertical rods are parallel to each other. Two ends of the transverse rod are fixedly connected to upper ends of the two vertical rods respectively. One first connection member 2 is arranged between the two supporting members 1. Two ends of the first connection member 2 are fixedly connected to corresponding corners of the two supporting members 1 respectively.

The two second connection members 3 are arranged between the two supporting members 1. Two ends of one of the two second connection members 3 are fixedly connected to a pair of two corresponding vertical rods of the two supporting members 1 respectively, and two ends of the other one of the two second connection members 3 are fixedly connected to the other pair of two corresponding vertical rods of the two supporting members 1 respectively. The two second connection members 3 are in the same horizontal plane, and each end of each of the two second connection members 3 is connected to a middle portion of a respective one of the vertical rods, so that a height difference exists between the second connection members 3 and the transverse rods and the first connection member 2.

The two third connection members 4 are arranged between the two second connection members 3. Two ends of one of the two third connection members 4 are fixedly connected to two corresponding ends of the two second connection members 3 respectively, and two ends of the other one of the two third connection members 4 are fixedly connected to the other two corresponding ends of the two second connection members 3 respectively.

Based on the above structure, a supporting pad may be designed, which includes a base pad, two first side pads, and a second side pad. The base pad is in the shape of a rectangle. A length of the base pad is equal to a length of each second connection member 3. A width of the base pad is equal to a length of each third connection member 4. Then, a pair of two opposing side edges of the base pad are fixedly connected to the two second connection members 3 respectively, and then, another pair of two opposing side edges of the base pad are fixedly connected to the two third connection members 4 respectively. A first end of each of the two first side pads is fixedly connected to a respective side edge of the base pad adjacent to a corresponding third connection member 4, and a second end of each of the two first side pads is folded upward and wrapped around a respective transverse rod. Then, the second end of each of the two first side pads away from the corresponding third connection member is fixed to a side of each of the two first side pads adjacent to a corresponding second connection member 3 through a Velcro tape. A first end of the second side pad is fixedly connected to a side edge of the base pad adjacent to the first connection member 2, and a second end of the second side pad is folded upward and wrapped around the first connection member 2, and then folded toward a side of the second side pad adjacent to a corresponding one of the two third connection members 4. The second end of the second side pad is fixed to the side of the second side pad adjacent to the corresponding one of the two third connection members 4 through a Velcro tape. The base pad can enable a pet to rest comfortably, and the first side pads and the second side pad can prevent a pet resting on the base pad from falling off the base pad.

Because only one first connection member 2 is connected, a pet can climb onto the base pad from the side without the first connection member 2, thereby reducing the climbing difficulty for pets.

### Embodiment 2

As shown in FIG. 2, in an embodiment of the present disclosure, the supporting assembly includes:
two second connection members 3, where two ends of each of the two second connection members 3 are respectively connected to the two supporting members 1, and the two second connection members 3 are located below the first connection member 2.

The two supporting members 1 are symmetrically arranged. The two supporting members 1 are each of a U-shape with two right-angled corners, i.e., each supporting member includes two vertical rods and one transverse rod. The two vertical rods are parallel to each other. Two ends of the transverse rod are fixedly connected to upper ends of the two vertical rods respectively. One first connection member 2 is arranged between the two supporting members 1. Two ends of the first connection member 2 are fixedly connected to corresponding corners of the two supporting members 1 respectively.

The two second connection members 3 are arranged between the two supporting members 1. Two ends of one of the two second connection members 3 are fixedly connected to a pair of two corresponding vertical rods of the two supporting members 1 respectively, and two ends of the other one of the two second connection members 3 are fixedly connected to the other pair of two corresponding vertical rods of the two supporting members 1 respectively. The two second connection members 3 are in the same horizontal plane, and each end of each of the two second connection members 3 is connected to a middle portion of a respective one of the vertical rods, so that a height difference exists between the second connection members 3 and the transverse rods and the first connection member 2.

Based on the above structure, a supporting pad may be designed, which includes a base pad, two first side pads, and a second side pad. The base pad is in the shape of a rectangle. A length of the base pad is equal to a length of each second connection member 3. A width of the base pad is equal to a length of each third connection member 4. Then, a pair of two opposing side edges of the base pad are fixedly connected to the two second connection members 3 respectively, and then, another pair of two opposing side edges of the base pad are fixedly connected to the two third connection members 4 respectively. A first end of each of the two first side pads is fixedly connected to a respective side edge of the base pad adjacent to a corresponding third connection member 4, and a second end of each of the two first side pads is folded upward and wrapped around a respective transverse rod. Then, the second end of each of the two first side pads away from the corresponding third connection member is fixed to a side of each of the two first side pads adjacent to a corresponding second connection member 3 through a Velcro tape. A first end of the second side pad is fixedly connected to a side edge of the base pad adjacent to the first connection member 2, and a second end of the second side pad is folded upward and wrapped around the first connection member 2, and then folded toward a side of the second side pad adjacent to a corresponding one of the two third connection members 4. The second end of the second side pad is fixed to the side of the second side pad adjacent to the corresponding one of the two third connection members 4 through a Velcro tape. The base pad can enable a pet to rest comfortably, and the first side pads and the second side pad can prevent a pet resting on the base pad from falling off the base pad.

Because only one first connection member 2 is connected, a pet can climb onto the base pad from the side without the first connection member 2, thereby reducing the climbing difficulty for pets.

In addition, compared with Embodiment 1, in this embodiment, the third connection members 4 are not provided, and the base pad does not need to be folded upward around the third connection members 4, so that the material consumption required for fabricating the base pad can be reduced, thereby reducing the fabrication costs.

The present disclosure has the following advantages.

The supporting assembly is mounted on the bed body, and a height difference exists between the supporting assembly and a top of the bed body, so that when the supporting pad is mounted, three sides of the supporting pad can be folded upward to protect a pet and prevent the pet from falling from the supporting pad. In addition, because the bed body has one side without the supporting pad, a pet may easily climb onto the supporting pad from that side of the bed body.

In the present disclosure, the terms such as “mount”, “connect”, “couple”, “fix”, and variants thereof should be interpreted in a broad sense. For example, “connection” may be a fixed connection, a detachable connection, or an integral connection; and “connection” may also be a direct connection or an indirect connection through an intermediate medium. For those of ordinary skill in the art, the specific meanings of the above terms in the present disclosure can be understood according to specific circumstances.

In the description of the present disclosure, it should be understood that the orientation or positional relationships indicated by the terms such as “inner” and “outer” are based on orientation or position relationships shown in the accompanying drawings, and are used only for ease and brevity of illustration and description, rather than indicating or implying that the mentioned apparatus or unit must have a particular orientation or must be constructed and operated in a particular orientation. Therefore, such terms should not be construed as limiting of the present disclosure.

In the description of this specification, the description with reference to the terms such as “an embodiment”, “some embodiments”, and “specific embodiment” means that specific features, structures, materials, or characteristics described in connection with the embodiment or example are embraced in at least one embodiment or example of the present disclosure. In this specification, exemplary descriptions of the foregoing terms do not necessarily refer to the same embodiment or example. Moreover, the described specific features, structures, materials, or characteristics may be combined in any suitable manner in one or more embodiments or examples.

The above description is merely preferred embodiments of the present disclosure, and is not intended to limit the present disclosure. To those skilled in the art, various modifications and variations may be made to the present disclosure. Any modification, equivalent replacement, or improvement made without departing from the spirit and principle of the present disclosure shall fall within the scope of protection of the present disclosure.

What is claimed is:

1. A pet bed, comprising:
a bed body; and
a supporting assembly, wherein the supporting assembly is connected to the bed body, and the supporting assembly is located at a position other than an upper end of the bed body and a lower end of the bed body.

2. The pet bed according to claim 1, wherein the bed body comprises:
two supporting members, wherein the two supporting members are arranged symmetrically; and
a first connection member, wherein two ends of the first connection member are respectively connected to the two supporting members.

3. The pet bed according to claim 2, wherein the supporting assembly comprises:
two second connection members, wherein two ends of each of the two second connection members are respectively connected to the two supporting members, and the two second connection members are located below the first connection member; and
two third connection members, wherein two ends of each of the two third connection members are respectively connected to the two second connection members.

4. The pet bed according to claim 2, wherein the supporting assembly comprises:
two second connection members, wherein two ends of each of the two second connection members are respectively connected to the two supporting members, and the two second connection members are located below the first connection member.
